(19) United States
(12) Patent Application Publication
(10) Pub. No.: US 2011/0301063 A1
(43) Pub. Date: Dec. 8, 2011

(54) MULTIPLEXING DERIVATIZED ANAYLTES USING MASS SPECTROSCOPY

(76) Inventors: Brian C. Netzel, Rochester, MN (US); Kendall W. Cradic, Byron, MN (US)

(21) Appl. No.: 13/202,253

(22) PCT Filed: Feb. 23, 2010
(86) PCT No.: PCT/US10/25056

§ 371 Date: Aug. 18, 2011

Related U.S. Application Data
(60) Provisional application No. 61/155,050, filed on Feb. 24, 2009.

(51) Int. Cl. C40B 30/10

(52) U.S. Cl. 506/12

(57) ABSTRACT

This document relates to methods and materials involved in simultaneously determining (i.e., multiplexing) the levels of an analyte in biological samples from multiple subjects using high pressure liquid chromatography-tandem mass spectrometry (LC-MS/MS). For example, methods and materials for derivatizing vitamin D metabolites in samples obtained from multiple subjects (e.g., humans), and combining samples for simultaneous analysis in a single assay are provided.

### CROSS-REFERENCE TO RELATED APPLICATIONS

This application claims the benefit of U.S. Provisional Application Ser. No. 61/155,050, filed Feb. 24, 2009. The disclosure of the prior applications is considered part of (and is incorporated by reference in) the disclosure of this application.

### BACKGROUND

1. Technical Field

This document relates to methods and materials involved in simultaneously determining (i.e., multiplexing) the levels of an analyte in biological samples from multiple subjects using high pressure liquid chromatography-tandem mass spectrometry (LC-MS/MS). For example, methods and materials for derivatizing vitamin D metabolites in samples obtained from multiple subjects (e.g., humans), and combining samples for simultaneous analysis in a single assay are provided.

2. Background Information

Mass spectrometry (MS) is an analytical technique for determining the component elements of a sample. The technique can quantify the amount of a compound in a sample. Tandem MS instrumentation permits multiple (i.e. two or more) stages of mass separation and analysis of a sample.

### SUMMARY

This document provides methods and materials for simultaneously determining the levels of an analyte in biological samples from multiple subjects using high pressure liquid chromatography-tandem mass spectrometry (LC-MS/MS). An analyte can be any bioactive molecule except a polypeptide, e.g., steroid, steroid hormone, vitamin, a primary amine containing molecule, or a ketone containing molecule. For example, an analyte can be a non-polypeptide analyte. The term “analyte” as used herein refers to a molecule other than a polypeptide. For example, an analyte can be a non-polypeptide analyte such as a steroid, a steroid hormone, vitamin, or a catecholamine. For example, methods and materials for derivatizing vitamin D metabolites in samples obtained from multiple subjects (e.g., humans), and combining samples for simultaneous analysis in a single assay are provided. Assay time per sample and/or solvent per sample can be decreased by using a LC-MS/MS system to distinguish between uniquely derivatized analytes in a pooled sample. The materials and methods described herein can be used to aid in diagnosis of pathologies related to a deficiency or excess of bioactive molecules, such as vitamin D metabolites.

For example, metabolites of vitamin D can be extracted from patient serum or plasma and derivatized by triazoline dione (TAD) chemicals. Multiple functional groups can be substituted at the 4-position of a TAD molecule. Individual patient samples can be derivatized with TAD molecules so that each sample contains a derivatized analyte having a different functional group.

Derivatized samples with different functional groups are then combined and run together in one assay. The LC-MS/MS system can identify the level of a vitamin D analyte and its internal standard associated with an individual patient based on the distinct molecular mass of the derivatizing reagent of the analyte.

In general, one aspect of this document provides a method for determining the amount of an analyte present in at least two different samples. The method comprises, or consists essentially of, using a pooled sample to determine the level of the analyte in each of at least two different samples by a mass spectroscopy technique. The pooled sample comprises the at least two different samples. A first sample of the at least two different samples contains the analyte in a first form, and a second sample of the at least two different samples contains the analyte in a second form. The analyte can be selected from the group consisting of steroids, steroid hormones, vitamins, and catecholamines. The analyte can be 25-hydroxyvitamin D₂ or 25-hydroxyvitamin D₃. The at least two different samples can comprise, or consist essentially of, a biological fluid. The biological fluid can be blood, plasma, serum, or urine. The method can comprise extracting the analyte from the biological fluid using solid phase extraction or liquid/liquid extraction. The at least two different samples can be taken from at least two mammals. The at least two mammals can be humans. The pooled sample can comprise an internal control or standard. The mass spectroscopy technique can comprise gas chromatography or liquid chromatography. The mass spectroscopy technique can comprise tandem mass spectroscopy. The first form of the analyte can comprise, or consist essentially of, a native form of the analyte. The second form of the analyte can comprise, or consists essentially of, a derivatized form of the analyte. The derivatized form can have a different molecular mass than the native form. The derivatized form can comprise a derivatizing reagent (e.g., a Cookson-type reagent). The derivatizing reagent can be PTAD, MBOTAD, DMEQTAD, FPTAD, CPTAD, ETAD, PROTAD, BTAD, BPTAD, TTAD, or MTAD. The method can comprise derivatizing the analyte before pooling the at least two samples. The method can comprise, or consist essentially of, determining the amount of the analyte present in at least 5, 10, or 25 different samples. The analyte, if present, in each of the at least 5, 10, or 25 different samples can be in a form that identifies which of the at least 5, 10, or 25 different samples the analyte originated.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description below. Other features, objects, and advantages of the invention will be apparent from the description and drawings, and from the claims.

### DESCRIPTION OF THE DRAWINGS

FIG. 1A contains examples of derivatizing reagents (e.g., Cookson-type reagents). FIG. 1B contains an example of a reaction of a Cookson-type derivatizing reagent with a vitamin D metabolite.

FIG. 2 is a schematic of sample preparation for multiplexed LC-MS/MS analysis.

FIG. 3 is a chromatogram showing elution of a sample containing derivatized 25-hydroxyvitamin D₂ and D₃ with FPTAD, PTAD, and MTAD.

FIG. 4 is a linear comparison of levels determined using pooled derivatized 25-hydroxyvitamin D₃ (combined samples from same patient) v. levels determined using underivatized 25-hydroxyvitamin D₃.

FIG. 5 is a linear comparison of levels determined using pooled derivatized 25-hydroxyvitamin D₃ (combined samples from different patients) v. levels determined using underivatized 25-hydroxyvitamin D₃.

FIG. 6 is a linear comparison of levels determined using the indicated TAD derivatizing reagent systems v. levels determined using underivatized 25-hydroxyvitamin D₃.

### DETAILED DESCRIPTION

This document provides methods and materials for simultaneously determining the levels of an analyte in biological samples from multiple subjects using high pressure liquid chromatography-tandem mass spectrometry (LC-MS/MS). For example, methods and materials for derivatizing vitamin D metabolites in samples obtained from multiple subjects (e.g., humans), and combining samples for simultaneous analysis in a single assay are provided.

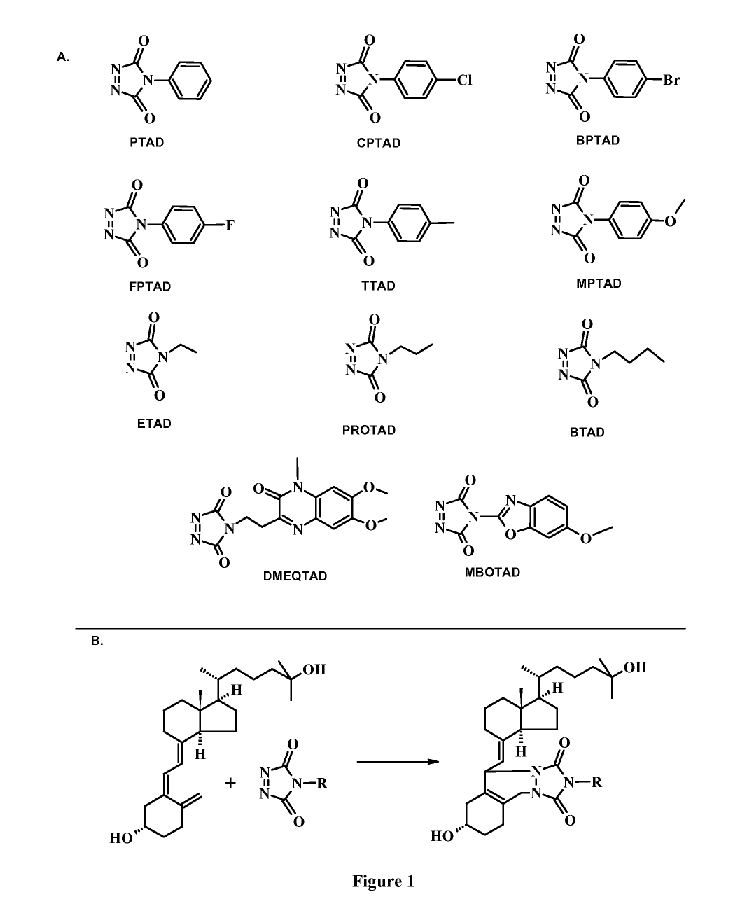

A method described herein can include the use of mass spectrometry techniques, such as gas chromatography-mass spectroscopy (GC-MS) or tandem mass spectrometry (MS/MS) techniques (e.g., a GC-MS/MS technique or liquid chromatography tandem mass spectrometry (LS-MS/MS) technique). Depending on the derivatizing reagent (e.g., Cookson-type reagent (FIG. 1)), a MS/MS technique can include a Q1 scan that is tuned to select ions of that correspond to the molecular mass of a functional group (e.g., phenyl, chloro-phenyl, or methoxy-phenyl, and others) of the derivatizing reagent. For example, the location of a molecular ion peak of a derivatized analyte on a mass spectrum can correspond to its molecular mass. An internal standard, such as deuterated standard, can be added to any sample, e.g., to evaluate sample recovery, precision, and/or accuracy. For example, hexadeuterated-25-hydroxyvitamin D₃ can be used as an internal standard in assays to measure vitamin D or vitamin D metabolites in patient samples.

### Samples and Sample Preparation

A sample for analysis can be any biological sample. For example, a sample can be a tissue (e.g., adipose, liver, kidney, heart, muscle, bone, or skin tissue) or biological fluid (e.g., blood, serum, plasma, urine, lachrymal fluid, CSF, or saliva) sample. The sample can be from a mammal. A mammal can be a human, dog, cat, primate, rodent, pig, sheep, cow, or horse.

A sample can be treated to remove components that could interfere with the mass spectrometry technique. A variety of techniques can be used based on the sample type. For example, tissue samples can be ground, purified, and extracted to free the analytes of interest from interfering components. In such cases, a sample can be centrifuged, filtered, and/or subjected to chromatographic techniques (e.g., solid phase extraction columns (SPE), C18 columns, and liquid/liquid extraction techniques) to remove interfering components (e.g., cells or tissue fragments). In some cases, a liquid/liquid extraction technique can be used for sample cleanup. For example, a non-polar solvent can be added to a sample. The non-polar solvent can have a higher affinity for the analyte of interest than the specimen matrix. The analyte then can be transferred into the solvent, which subsequently can be removed from the specimen matrix with the analyte and its internal standard within it.

In some cases, reagents known to precipitate, bind, or dissociate impurities or interfering components can be added. For example, whole blood samples can be treated using conventional clotting techniques to remove red and white blood cells and platelets. A sample can be de-proteinized. For example, a plasma sample can have serum proteins precipitated using conventional reagents such as acetonitrile, KOH, NaOH, acetonitrile, acetone, or others, followed by centrifugation or filtration of the sample. A sample can be acidified to, e.g., dissociate 25-hydroxyvitamin binding proteins.

A sample can be subjected to an affinity purification step to purify an analyte of interest. An affinity purification step can employ the addition to the sample of an antibody that is specific for an analyte to be detected. The antibody can be bound to a solid support (e.g., a bead, well, or plate, as known to those having ordinary skill in the art) or can be in solution. Antibodies in solution can be captured using secondary antibodies bound to a solid support, for example. Analytes can be eluted from the antibodies by any technique (e.g., the use of high salt solutions, pH changes, or alcoholic solutions (e.g., ethanol)).

Any appropriate derivatizing agent can be used to derivatize an analyte prior to MS analysis. Derivatization can provide suitable sites for protonation or cationization, or electron addition or anionization, of an analyte from an individual sample. A method described herein can include using a derivatizing agent configured for rapid and quantitative reaction with an analyte of interest. See, e.g., Higashi and Shimada, Anal. Bioanal. Chem., 378: 875-882 (2004). For example, Cookson-type reagents can be used to derivatize vitamin D metabolites and analogs as described elsewhere (e.g., Higashi et al., Biol. Pharm. Bull., 24: 738-743 (2001)). In some cases, reagents, such as silylation reagents derivatizing hydroxyl, carboxylic acid, amine, thiol, or phosphate groups on an analyte of interest, acylation reagents for conversion of compounds with active hydrogen such as —OH, —SH, and —NH into esters, thioesters and amines, and alkylation or esterification reagents for derivatization of carboxylic acids and other acidic functional groups, can be used with the methods described herein. Examples of analytes and derivatizing agents for multiplexed MS analysis are provided in Table 1.

TABLE 1
Analytes and derivatizing reagents.

| Analyte | Derivatizing Agent |
|---|---|
| Vitamin D metabolites | Cookson-type reagents |
| Estrogens and other phenol containing | Sulfonyl chloride reagents |
| analytes (e.g., catecholamines and | (e.g., dansyl chloride and |
| metanephrines) | BANS—Cl (5-dibutylamino-1- |
| Primary amine containing analytes | napthalenesulfonyl-chloride) |
| (e.g., catecholamines) | |
| Ketone containing molecules | Girard's reagents T, P, D |
| (e.g., aldosterone, cortisol, | Hydroxylamines |
| and testosterone) | |

In some cases, a derivatizing reagent can be configured for fluorometric analysis. For example, a derivatizing reagent can be a fluorogenic molecule or can have a fluorescent label. A method described herein can use a fluorogenic molecule to differentiate derivatized analytes and identify the source of a derivatized analyte based on emission spectra or detection of fluorescence using a spectrophotometer, for example. In some cases, pooled derivatized analytes can be fractionated by and/or analyzed based on emission of fluorescence using chromatography techniques (e.g., LC or high performance liquid chromatography (HPLC), LC-MS/MS, or HPLC-MS/MS).

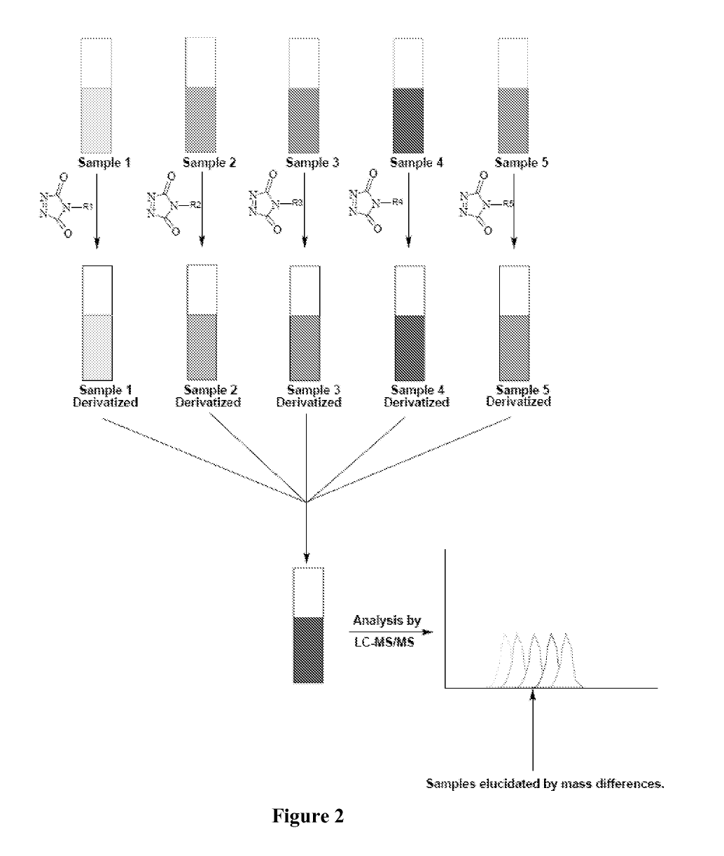

A method described herein can be used to derivatize individual samples with similar derivatizing reagents, but different functional groups. Post derivatization, samples can be combined and assayed in one injection. The differences in the derivatizing reagent's molecular weight can allow for differentiation within the mass spectrometer (FIG. 2). For example, derivatization of vitamin D metabolites can be performed with a derivatizing reagent (e.g., a Cookson-type reagent) such as those shown in FIG. 1. A Cookson-type reagent (4-substituted 1,2,4-triazoline-3,5-dione (TAD)), can react with a neutral steroid to selectively derivatize the molecule. In some cases, 4-phenyl-TAD (PTAD), 4-[4-(methoxy-2-benzoxazolyl)phenyl]-TAD (MBOTAD), 4-[2-(6,7-dimethoxy-4-methyl-3-oxo-3,4-dihydroquinoxalyl)ethyl]-TAD (DMEQTAD), 4-(4-fluoro-phenyl)-TAD (FPTAD), 4-(4-chloro-phenyl)-TAD (CPTAD), 4-ethyl-TAD (ETAD), 4-propyl-TAD (PROTAD), 4-butyl-TAD (BTAD), 4-(4-bromo-phenyl)-TAD (BPTAD), 4-tolyl-TAD (TTAD), 4-(4-methoxy-phenyl)-TAD (MPTAD), and 4-methyl-TAD (MTAD) can be used as derivatizing reagents. For example, individual samples from at least two, three, four, five, six, seven, eight, nine, or more subjects can be labeled using a different reagent (e.g., PTAD, MBOTAD, DMEQTAD, FPTAD, CPTAD, ETAD, PROTAD, BTAD, BPTAD, TTAD, MPTAD, and/or MTAD) for each subject's sample, to derivatize an analyte of interest individually. Individual samples can be pooled and each derivatized analyte in the combined sample and its corresponding internal standard can be specifically detected by using GC-MS or LC-MS/MS to differentiate on the basis of the TAD substitution (i.e., ionization or fragmentation properties of functional groups and/or molecular mass), as shown in FIG. 2. In some cases, a fluorogenic TAD molecule (e.g., 4-[2-(6,7-dimethoxy-4-methyl-3-oxo-3,4-dihydroquinoxalyl)ethyl]-TAD (DMEQ-TAD)) can allow fluorometric differentiation of derivatized analytes as described elsewhere (e.g., Harada et al. Nat. Toxins, 5: 201-207 (1997)).

An internal standard can be any compound that would be expected to behave under the sample preparation conditions in a manner similar to that of one or more of the analytes of interest. For example, a stable-isotope-labeled version of an analyte of interest can be used, such as a deuterated or C13 labeled version of an analyte of interest. While not being bound by any theory, the physicochemical behavior of such stable-isotope-labeled compounds with respect to sample preparation and signal generation would be expected to be identical to that of the unlabeled analyte, but clearly differentiable by mass on the mass spectrometer. In certain methods, a stable isotope internal standard (e.g., d6 25-hydroxyvitamin D₃ and d3 25-hydroxyvitamin D₂) can be used.

To improve run time and minimize hands-on sample preparation, on-line extraction and/or analytical chromatography of a sample can be used. On-line extraction and/or analytical chromatography can be used, e.g., in GC-MS or LC-MS/MS techniques. For example, in certain methods, a sample, such as a deproteinized plasma sample, can be extracted using an extraction column, followed by elution onto an analytical chromatography column. The columns can be useful to remove interfering components as well as reagents used in earlier sample preparation steps (e.g., to remove reagents such as acetonitrile or unreacted reagents). Systems can be coordinated to allow the extraction column to be running while an analytical column is being flushed and/or equilibrated with solvent mobile phase, and vice-versa, thus improving efficiency and run-time. Any extraction and analytical column with appropriate solvent mobile phases and gradients can be used with the methods and materials described herein.

### Mass Spectrometry

After sample preparation, a sample can be subjected to a mass spectrometry (MS) technique. A mass spectrometry technique can use atmospheric pressure chemical ionization (APCI) in the positive ion mode or electrospray ionization (ESI) to generate precursor positive or negative ions. Analytes of interest can exist as charged species, such as protonated molecular ions [M°+H⁺] or [M+H⁺] or as negatively charged ions [M−H⁻] in the mobile phase. During the ionization phase, the molecular ions are desorbed into the gas phase at atmospheric pressure and then focused into the mass spectrometer for analysis and detection. Additional information relating to atmospheric pressure chemical ionization is described elsewhere (see, e.g., U.S. Pat. No. 6,692,971).

MS analysis can be conducted with a single mass analyzer (MS) or a “tandem in space” analyzer such as a triple quadrupole tandem mass spectrometer (MS/MS). Using MS/MS, the first mass filter (Quadrople 1, Q1) can select, or can be tuned to select, independently, one or more of the molecular ions of derivatized analytes, and the internal standard. The second mass filter (Q3) is tuned to select specific product or fragment ions related to the analyte of interest. Between these two mass filtration steps, the precursor molecular ions can undergo collisionally-induced dissociation (CID) at Q2 to produce product or fragment ions. The previously-described mass spectrometry technique can also be referred to as multiple reaction monitoring, or MRM. In multiple reaction monitoring, both quadrupoles Q1 and Q3 can be fixed (or tuned) each at a single mass, whereas Q2 can serve as a collision cell.

The amount of each analyte of interest can be determined by comparing the area or peak height of precursor or product transitions, or both, with those of a standard calibration curve, e.g., a standard calibration curve generated from a series of defined concentrations of pure analyte standards. Variables due to the extraction and the LC-MS/MS instrumentation can be normalized by normalizing peak areas or peak heights of the analyte of interest to the peak areas or peak heights of the internal standard.

Any GC-MS machine, tandem MS machine, or LC-MS/MS machine can be used, including the API 4000 triple quadrupole tandem mass spectrometer (ABI-SCIEX, Toronto, Canada) or the TLX-4 mutliplex LC system coupled with the TSQ Quantum Access triple quadrupole tandem mass spectrometer (Thermo Fisher Scientific, Waltham, Mass.). Software for tuning, selecting, and optimizing ion pairs is also available, e.g., Analyst Software Ver. 1.4 (ABI-SCIEX).

### Methods for Diagnosis

The methods described herein can be used in various diagnostic applications to monitor analyte-related pathologies. For example, pharmacokinetics, liver function, adrenal function, vitamin D and calcium homeostasis, and vitamin D replacement therapies can be assessed as described herein. For example, the total amount of vitamin D in an individual sample, such as a human patient sample, can be compared with clinical reference values to diagnose a vitamin D deficiency or hypervitaminosis D.

### Robotic Systems

In some cases, a robotic system can be designed and used to perform one or more of the methods described herein. For example, a 16-channel robot can be designed to handle sample transfer, and a 96-channel robot can be designed to handle all additions, extractions, protein precipitations, and transfers from one plate to another. In some cases, a method can be performed as set forth in Table 2.

TABLE 2
An example of a sample preparation technique.

| Step | Description |
|---|---|
| Sample transfer | Sample is transferred from sample tube to |
| | “extraction plate” (e.g., a 96-well 2 |
| | mL/well plate). This can be performed |
| | using a liquid handling robot. |
| Internal standard addition | Internal standard is added to each sample |
| | well in the extraction plate. This can be |
| | performed using a liquid handling robot. |
| Protein precipitation | Acetone or acetonitrile is added to each |
| | well. This can be performed using a liquid |
| | handling robot that can disrupt the binding |
| | proteins that may otherwise cling to the |
| | analyte. |
| Extraction | Ethyl acetate is added to each well and |
| | mixed to extract each specimen by a |
| | liquid/liquid technique. |
| Transfer | The ethyl acetate layer (with analytes of |
| | interest) is transferred to a “derivatization |
| | plate” (e.g., a second plate that contains |
| | nothing at this point). This can be |
| | performed using a liquid handling robot. |
| Derivatization | A liquid handling robot can transfer the |
| | derivatization reagents to their appropriate |
| | plate. Derivatization is allowed to occur. |
| Drying/reconstituting | Each plate is dried under a dry nitrogen |
| | stream while being heated. The liquid |
| | handling robot then can be used to |
| | reconstitute each plate in a mixture of |
| | methanol/water. The contents of the plates |
| | can be combined into one common plate in |
| | preparation for analysis on the LC-MS/MS. |

The invention will be further described in the following examples, which do not limit the scope of the invention described in the claims.

### EXAMPLES

### Example 1

### Derivatized Vitamin D

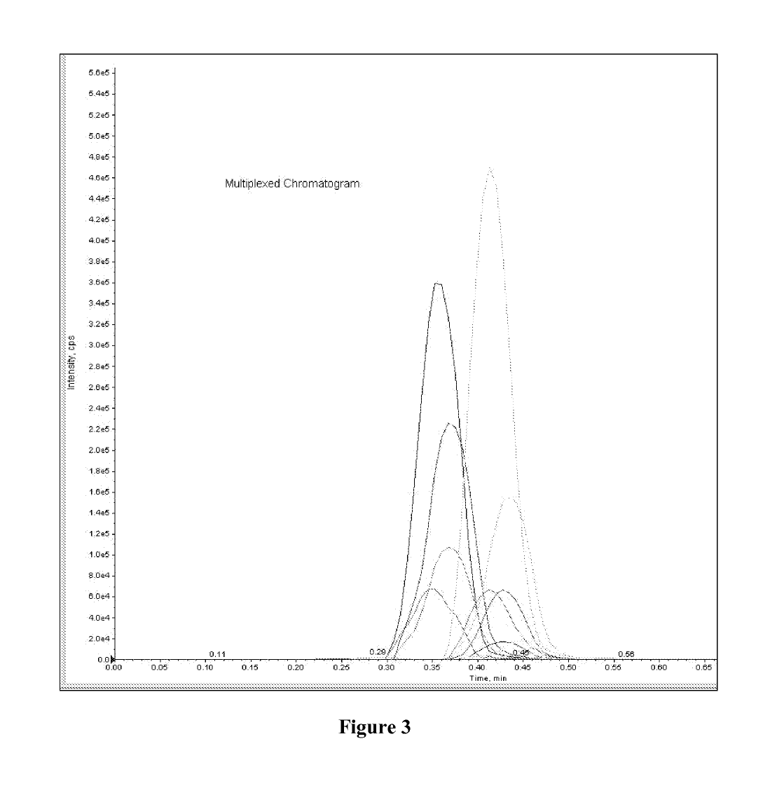

The following results demonstrate that Cookson-type reagents can be used to derivatize 25-hydroxyvitamin D₂ and 25-hydroxyvitamin D₃ for use with analysis via LC-MS/MS-based techniques. 25-hydroxyvitamin D₂ and 25-hydroxyvitamin D₃ and stable isotope labeled d6-25-hydroxyvitamin D₃ internal standard were derivatized with each of MTAD, PTAD, and FPTAD. Ion pairs were obtained for each compound. Each of the nine ion pairs (one for each derivatized product of 25-hydroxyvitamin D₂, D₃, and internal standard) were eluted from the column. FIG. 3 shows a depiction of the combined samples containing PTAD, FPTAD, and MTAD derivatized 25-hydroxyvitamin D₂ and D₃ in a single injection.

### Example 2

### Comparison of Multiplex Technique and Conventional Assay

Human serum samples from 110 subjects were de-identified and d6-internal standard was added. The samples were extracted via a solid phase extraction mechanism. After elution from the cartridges, the samples were dried down under a flow of nitrogen at 45° C. Sample extracts were exposed to a Cookson-type reagent (FPTAD, MTAD, and PTAD) in acetonitrile in separate tubes and allowed to react at room temperature for 15 minutes. The derivatized samples were dried down and reconstituted in 70% Methanol/water. Corresponding samples were combined into one tube (i.e. three derivatized samples in each of 100 tubes), and assayed using a TLX-4 mutliplex LC system coupled with the ABI-SCIEX API 4000 triple quadrupole tandem mass spectrometer system or the TSQ Quantum Access triple quadrupole tandem mass spectrometer system. Underivatized samples of 25-hydroxyvitamin D₂ and 25-hydroxyvitamin D₃ were applied to the LC-MS/MS system. The levels 25-hydroxyvitamin D₃, and derivatized 25-hydroxyvitamin D₃ for each patient are shown in Table 3.

TABLE 3
Levels of 25-hydroxyvitamin D₃ and
derivatized 25-hydroxyvitamin D₃.

| Patient | 25HD3 | FPTAD | MTAD | PTAD |
|---|---|---|---|---|
| 1 | 22 | 24.8 | 24 | 23.8 |
| 2 | 14 | 16.1 | 14.6 | 15.8 |
| 3 | 50 | 50.4 | 50.7 | 48.7 |
| 4 | 6.5 | 6.93 | 6.34 | 6.4 |
| 5 | 14 | 12.8 | 13 | 14.1 |
| 6 | 13 | 12.7 | 13.4 | 13.2 |
| 7 | 7.3 | 7.09 | 7.79 | 7.4 |
| 8 | 34 | 33.6 | 34.6 | 35.2 |
| 9 | 30 | 29.4 | 29.9 | 28.7 |
| 10 | 19 | 20.2 | 20.6 | 20.9 |
| 11 | 39 | 39.3 | 38.1 | 37.7 |
| 12 | 5.7 | 5.51 | 5.84 | 5.6 |
| 13 | 31 | 30.4 | 31.7 | 31.9 |
| 14 | 15 | 15.5 | 14.9 | 15.4 |
| 15 | 17 | 17.3 | 16.8 | 16.4 |
| 16 | 36 | 35.2 | 35.2 | 36.8 |
| 17 | 35 | 35.9 | 35.1 | 34 |
| 18 | 26 | 25.3 | 26.6 | 25.6 |
| 19 | 33 | 33.8 | 32.8 | 33.7 |
| 20 | 28 | 28.6 | 26.2 | 27.7 |
| 21 | 30 | 29.6 | 30 | 29.3 |
| 22 | 9.8 | 11.1 | 9.47 | 9.99 |
| 23 | 17 | 17.2 | 17 | 16.8 |
| 24 | 11 | 11.7 | 11.8 | 10.9 |
| 25 | 35 | 35.3 | 33.7 | 34.5 |
| 26 | 33 | 32.7 | 32.2 | 31.6 |
| 27 | 31 | 32.3 | 30.7 | 32.1 |
| 28 | 43 | 43.8 | 44.4 | 43.5 |
| 29 | 24 | 22.9 | 23.1 | 23.7 |
| 30 | 16 | 14.8 | 15.6 | 15.3 |
| 31 | 28 | 29.2 | 28.9 | 27.4 |
| 32 | 8.6 | 9.08 | 8.33 | 8.6 |
| 33 | 22 | 20.7 | 21.1 | 22.1 |
| 34 | 14 | 14.3 | 14.2 | 14 |
| 35 | 33 | 33.9 | 34.1 | 33.2 |
| 36 | 29 | 29.3 | 27.1 | 27.9 |
| 37 | 30 | 29.8 | 29.1 | 30.5 |
| 38 | 22 | 22.9 | 22.3 | 21.6 |
| 39 | 37 | 35.5 | 36.2 | 37.4 |
| 40 | 24 | 24 | 23.2 | 22.1 |
| 41 | 9.4 | 9.8 | 8.65 | 8.87 |
| 42 | 5.7 | 5.39 | 6.03 | 5.63 |
| 43 | 38 | 38.1 | 37.8 | 37.6 |
| 44 | 49 | 46.9 | 48.3 | 48.1 |
| 45 | 29 | 27.9 | 26.5 | 29.6 |
| 46 | 34 | 33.5 | 32.1 | 33.2 |
| 47 | 13 | 14.3 | 13.2 | 14.2 |
| 48 | 43 | 42.7 | 41.3 | 41.1 |
| 49 | 40 | 39.4 | 39.3 | 41.3 |
| 50 | 29 | 27.4 | 29.3 | 27.7 |
| 51 | 12 | 11.2 | 11.1 | 11.4 |
| 52 | 44 | 46.7 | 44.6 | 44.9 |
| 53 | 6.2 | 6.18 | 7.03 | 6.6 |
| 54 | 31 | 30.4 | 29.8 | 30.9 |
| 55 | 31 | 28.2 | 29.7 | 29.7 |
| 56 | 14 | 14.1 | 13.6 | 13.5 |
| 57 | 3.7 | 3.85 | 3.75 | 3.97 |
| 58 | 38 | 40.3 | 38.8 | 38.3 |
| 59 | 22 | 23.8 | 24.5 | 24.2 |
| 60 | 33 | 31.1 | 31.9 | 32.3 |
| 61 | 66 | 63 | 64.7 | 63.3 |
| 62 | 33 | 33.3 | 31.3 | 32.9 |
| 63 | 24 | 23.9 | 23.2 | 23.8 |
| 64 | 22 | 22 | 23.6 | 22.8 |
| 65 | 32 | 32.2 | 32.2 | 29.2 |
| 66 | 23 | 21.3 | 23 | 24.3 |
| 67 | 29 | 28 | 26.6 | 30.3 |
| 68 | 13 | 12.1 | 12.8 | 12.5 |
| 69 | 16 | 16.4 | 16.4 | 16.2 |
| 70 | 33 | 31.8 | 33.1 | 34.2 |
| 71 | 12 | 12.6 | 12.4 | 12.3 |
| 72 | 32 | 31.9 | 30.4 | 30.8 |
| 73 | 7.7 | 7.59 | 7.4 | 7.86 |
| 74 | 36 | 32.1 | 32.5 | 35.4 |
| 75 | 4.9 | 5.59 | 5.04 | 5.4 |
| 76 | 43 | 41.1 | 42.2 | |
| 77 | 42 | 41.3 | 40.2 | 43.5 |
| 78 | 34 | 33.6 | 36 | 32.3 |
| 79 | 29 | 27.3 | 28.4 | 27.6 |
| 80 | 2.9 | 3.39 | 2.86 | 3.5 |
| 81 | 32 | 30.5 | 31.3 | 32.4 |
| 82 | 44 | 44.5 | 43.8 | 45.7 |
| 83 | 36 | 35.6 | 36.4 | 34.8 |
| 84 | 46 | 45.6 | 44.5 | 46.4 |
| 85 | 16 | 14.2 | 12.8 | 14.4 |
| 86 | 8.2 | 7.86 | 8.01 | 8.21 |
| 87 | 18 | 17.7 | 17.2 | 17.1 |
| 88 | 18 | 18.3 | 17.4 | |
| 89 | 9.5 | 9.78 | 9.51 | 9.47 |
| 90 | 18 | 17.9 | 17 | 18.2 |
| 91 | 33 | 32.6 | 33.5 | 33.1 |
| 92 | 27 | 28.4 | 26.5 | 25.5 |
| 93 | 33 | 34.7 | 33.1 | 33.1 |
| 94 | 15 | 13.8 | 15.9 | 14.6 |
| 95 | 34 | 33.3 | 35.2 | 34.6 |
| 96 | 26 | 28.3 | 24.8 | 26.2 |
| 97 | 32 | 35.8 | 34.5 | 32.4 |
| 98 | 37 | 35.8 | 38.1 | 35.6 |
| 99 | 27 | 28 | 27.2 | 27.3 |
| 100 | 32 | 33.2 | 31 | 33.2 |

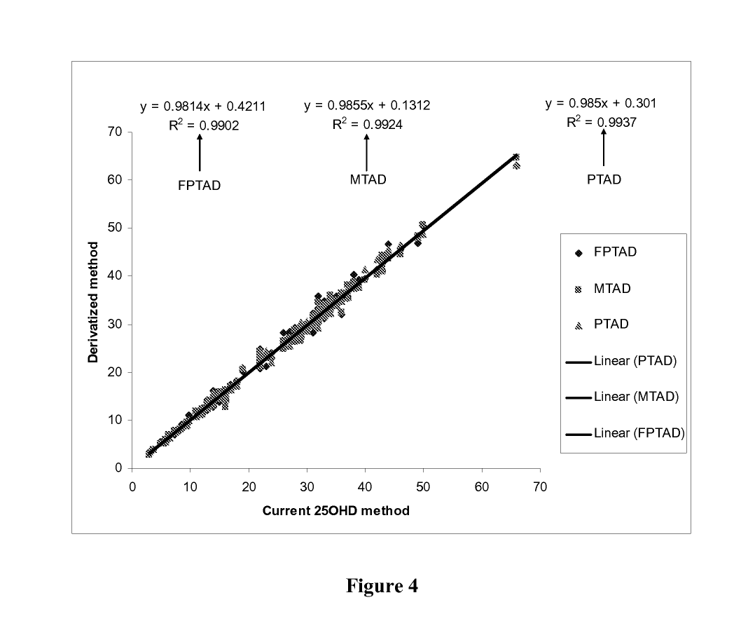

FIG. 4 shows the linear correlation of levels determined using the single sample/subject 25-hydroxyvitamin D assay vs. those determine using pooled derivatized 25-hydroxyvitamin D₃ (R²=0.9902 (FPTAD-derivatized samples), 0.9924 (MTAD-derivatized samples), and 0.9937 (PTAD-derivatized samples). These results demonstrate that combined derivatized samples can be analyzed by LC-MS/MS for simultaneous determination of 25-hydroxyvitamin D₃ levels from multiple subjects with the accuracy and specificity of conventional assays.

### Example 3

### Simultaneous Analysis of Samples from Two Patients

Two sets of 30 patient samples were used for this analysis. The samples of the first set (Patient Sample Nos. 1-30) were extracted and derivatized with MTAD, and the samples of the second set (Patient Sample Nos. 31-60) were extracted and derivatized with PTAD, using the techniques described in Example 2. The samples were combined as follows: Sample Nos. 1 with 31, 2 with 32, . . . , and 30 with 60. Underivatized samples were applied to the LC-MS/MS system (1 sample/injection). The combined samples were applied to the LC-MS/MS system (2 samples/injection) and analyzed. The results are shown in Table 4.

TABLE 4
Levels of MTAD-, PTAD-derivatized and
underivatized 25-hydroxyvitamin D₃

| Patient | Routine | Derivatized | |
|---|---|---|---|
| Sample No. | 25HD3 | 25HD3 | Reagent |
| 1 | 0 | 0 | MTAD |
| 2 | 15 | 14.2 | |
| 3 | 37 | 34.1 | |
| 4 | 17 | 17.1 | |
| 5 | 22 | 19.9 | |
| 6 | 32 | 27.8 | |
| 7 | 17 | 17.8 | |
| 8 | 37 | 32.1 | |
| 9 | 47 | 48.1 | |
| 10 | 33 | 27.3 | |
| 11 | 25 | 28.1 | |
| 12 | 46 | 45.4 | |
| 13 | 83 | 87.7 | |
| 14 | 26 | 31.4 | |
| 15 | 38 | 41.4 | |
| 16 | 53 | 55.1 | |
| 17 | 20 | 17.6 | |
| 18 | 17 | 17.3 | |
| 19 | 17 | 18.1 | |
| 20 | 35 | 32.7 | |
| 21 | 11 | 12.1 | |
| 22 | 32 | 30.5 | |
| 23 | 45 | 45.9 | |
| 24 | 42 | 39.3 | |
| 25 | 8.8 | 7.8 | |
| 26 | 27 | 23.6 | |
| 27 | 18 | 18.5 | |
| 28 | 16 | 14.6 | |
| 29 | 37 | 40.6 | |
| 30 | 28 | 30.1 | |
| 31 | 19 | 19.2 | PTAD |
| 32 | 41 | 43.8 | |
| 33 | 26 | 25.6 | |
| 34 | 14 | 13.7 | |
| 35 | 43 | 40 | |
| 36 | 24 | 21.7 | |
| 37 | 15 | 13.6 | |
| 38 | 42 | 42.1 | |
| 39 | 8.9 | 8.47 | |
| 40 | 6.7 | 6.34 | |
| 41 | 42 | 45.9 | |
| 42 | 45 | 47.3 | |
| 43 | 14 | 13 | |
| 44 | 18 | 20.2 | |
| 45 | 31 | 29.5 | |
| 46 | 18 | 16.5 | |
| 47 | 42 | 44.6 | |
| 48 | 29 | 28.8 | |
| 49 | 38 | 36.7 | |
| 50 | 23 | 24.3 | |
| 51 | 36 | 37.5 | |
| 52 | 62 | 59.8 | |
| 53 | 29 | 30.8 | |
| 54 | 40 | 39.9 | |
| 55 | 12 | 11.3 | |
| 56 | 42 | 43.8 | |
| 57 | 13 | 13.9 | |
| 58 | 23 | 23.6 | |
| 59 | 52 | 50.8 | |
| 60 | 15 | 16 | |

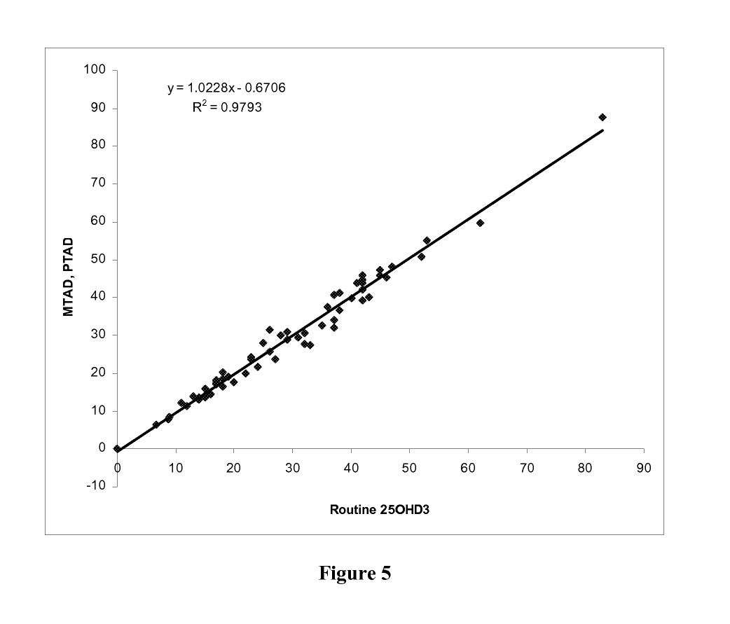

FIG. 5 shows a linear comparison of the derivatized 25-hydroxyvitamin D₃ (Derivatized-25HD3) values vs. the underivatized 25-hydroxyvitamin D₃ (Routine 25HD3) values (R²=0.9793). These results demonstrate that derivatized samples from different patients can be combined for mutliplexed LC-MS/MS analysis with the accuracy and specificity of underivatized individually analyzed samples.

### Example 6

### Comparison of Five TAD Derivatizing Reagent Systems with Routine Assay Results

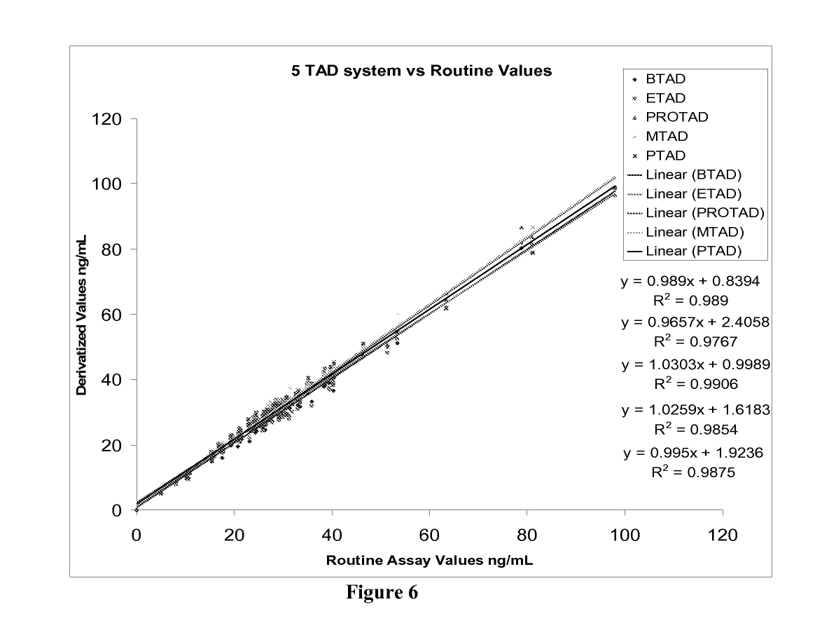

480 samples were analyzed using five derivatizing reagents and were analyzed using a “routine” assay that was performed with no derivatization and was performed individually (i.e., not combined). These results were analyzed on a linear regression versus a “routine” assay. The x-axis presents the results using the “routine” assay, and the y-axis presents each batch of patient samples assayed using derivatizing reagents (FIG. 6). Each derivatizing reagent contained 96 patient samples and data points. These results demonstrate that addition of a greater number of derivatizing reagents, and thus pooling more specimens, has no effect on the accuracy or precision of the method as compared to the classical underivatized method.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method for determining the amount of an analyte present in at least two different samples, wherein said method comprises using a pooled sample to determine the level of said analyte in each of said at least two different samples by a mass spectroscopy technique, wherein said pooled sample comprises said at least two different samples, wherein a first sample of said at least two different samples contains said analyte in a first form and a second sample of said at least two different samples contains said analyte in a second form.

2. The method of claim 1, wherein said analyte is selected from the group consisting of steroids, steroid hormones, vitamins, and catecholamines.

3. The method of claim 2, wherein said analyte is 25-hydroxyvitamin D₂ or 25-hydroxyvitamin D₃.

4. The method of claim 1, wherein said at least two different samples comprise a biological fluid.

5. The method of claim 4, wherein said biological fluid is blood, plasma, or serum.

6. The method of claim 4, wherein said method comprises extracting said analyte from said biological fluid using solid phase extraction.

7. The method of claim 4, wherein said method comprises extracting said analyte from said biological fluid using liquid/liquid extraction.

8. The method of claim 1, wherein said at least two different samples are taken from at least two mammals.

9. The method of claim 8, wherein said at least two mammals are humans.

10. The method of claim 1, wherein said pooled sample comprises an internal control.

11. The method of claim 1, wherein said mass spectroscopy technique comprises gas chromatography.

12. The method of claim 1, wherein said mass spectroscopy technique comprises liquid chromatography.

13. The method of claim 1, wherein said mass spectroscopy technique comprises tandem mass spectroscopy.

14. The method of claim 1, wherein said first form comprises a native form of said analyte.

15. The method of claim 1, wherein said second form comprises a derivatized form of said analyte.

16. The method of claim 15, wherein said derivatized form has a different molecular mass than said native form.

17. The method of claim 16, wherein said derivatized form comprises a Cookson-type reagent.

18. The method of claim 17, wherein said Cookson-type reagent is PTAD, MBOTAD, DMEQTAD, FPTAD, CPTAD, ETAD, PROTAD, BTAD, BPTAD, TTAD, or MTAD.

19. The method of claim 1, wherein said method comprises derivatizing said analyte before pooling said at least two samples.

20. The method of claim 1, wherein said method comprises determining the amount of said analyte present in at least 5 different samples, wherein said analyte, if present, in each of said at least 5 different samples is in a form that identifies which of said at least 5 different samples said analyte originated.

21. The method of claim 1, wherein said method comprises determining the amount of said analyte present in at least 10 different samples, wherein said analyte, if present, in each of said at least 10 different samples is in a form that identifies which of said at least 10 different samples said analyte originated.

22. The method of claim 1, wherein said method comprises determining the amount of said analyte present in at least 25 different samples, wherein said analyte, if present, in each of said at least 25 different samples is in a form that identifies which of said at least 25 different samples said analyte originated.
